(19) United States
(12) Patent Application Publication
(10) Pub. No.: US 2007/0278193 A1
(43) Pub. Date: Dec. 6, 2007

(54) Device and method to create a low divergence, high power laser beam for material processing applications

(75) Inventor: Thomas Hofmann, San Diego, CA (US)

Correspondence Address: Matthew K. Hillman;Cymer, Inc., Legal Dept., 17075 Thornmint Court, MS/4-2C, San Diego, CA, 92127-2413, US

(73) Assignee: Cymer, Inc., San Diego, CA (US)

(21) Appl. No.: 11/447,379

(22) Filed: Jun. 5, 2006

(51) Int. Cl. B23K 26/00

(52) U.S. Cl. 219/121.6

(57) ABSTRACT

A thin beam laser crystallization apparatus for selectively melting a film deposited on a substrate is disclosed having a laser source producing a pulsed laser output beam, the source having an oscillator comprising a convex reflector and a plano output coupler; and an optical arrangement focusing the beam in a first axis and spatially expanding the beam in a second axis to produce a line beam for interaction with the film.

### CROSS-REFERENCE TO RELATED APPLICATIONS

The present invention is related to copending, co-owned U.S. patent application entitled, “DEVICE AND METHOD TO STABILIZE BEAM SHAPE AND SYMMETRY FOR HIGH ENERGY PULSED LASER APPLICATIONS” by Hofmann, attorney docket number 2006-0039-01 filed concurrently herewith, to copending, co-owned U.S. patent application entitled, “HIGH POWER EXCIMER LASER WITH PULSE STRETCHER” to Hofmann et al., attorney docket number 2006-0040-01 filed concurrently herewith, to U.S. application Ser. No. 11/261,948, titled “SYSTEMS AND METHOD FOR GENERATING A LASER SHAPED AS A LINE BEAM,” filed on Oct. 28, 2005, to U.S. application Ser. No. 10/781,251, titled “VERY HIGH ENERGY, HIGH STABILITY GAS DISCHARGE LASER SURFACE TREATMENT SYSTEM,” filed on Feb. 18, 2004, to U.S. application Ser. No. 10/884,101, titled “LASER THIN FILM POLY-SILICON ANNEALING OPTICAL SYSTEM,” filed on Jul. 1, 2004, and to U.S. application Ser. No. 11/138,001, titled “SYSTEMS AND METHODS FOR IMPLEMENTING AN INTERACTION BETWEEN A LASER SHAPED AS A LINE BEAM AND A FILM DEPOSITED ON A SUBSTRATE” filed on May 26, 2005, the disclosures of each of which are hereby incorporated by reference herein.

### FIELD OF THE INVENTION

The present invention relates to pulsed, gas discharge lasers. The present invention is particularly, but not exclusively useful as a high power laser beam having relatively low divergence along one axis.

### BACKGROUND OF THE INVENTION

In many applications, it is desirable that the shape and/or symmetry of pulses within a high energy pulse train are stable from pulse-to-pulse. By way of example, but not limitation, one such application is the use of a high-energy, pulsed laser beam to melt an amorphous silicon film to induce crystallization of the film upon re-solidification, for the purpose of manufacturing thin film transistors (TFT's).

Many laser material processing applications prescribe the use of a high power laser beam having a beam shape, e.g., cross-section, that is dimensionally accurate. For example, laser crystallization of an amorphous silicon film that has been deposited on a substrate, e.g., glass, represents a promising technology for the production of material films having relatively high electron mobilities. More specifically, in one process, a high-energy, pulsed laser beam may be used to melt an amorphous silicon film to induce crystallization of the film upon re-solidification. Once crystallized, this material can then be used to manufacture (TFT's) and in one particular application, TFT's suitable for use in relatively large liquid crystal displays (LCD's). Other applications for crystallized silicon films may include Organic LED (OLED), System on a Panel (SOP), flexible electronics and photovoltaics. In more quantitative terms, high volume production systems may be commercially available in the near future capable of quickly crystallizing a film having a thickness of about 90 nm and a width of about 700 mm or longer.

Laser crystallization may be performed using pulsed laser light that is optically shaped to a line beam, e.g., laser light that is focused in a first axis, e.g., the short-axis, and expanded in a second axis, e.g., the long-axis. Typically, the first and second axes are mutually orthogonal and both axes are approximately orthogonal to a central ray traveling toward the film. An exemplary line beam for laser crystallization may have a beam width at the film of less than about 20 microns, e.g. 3-4 microns, and a beam length of about 700 mm, or larger. With this arrangement, the film can be scanned or stepped in a direction parallel to the beam width to sequentially melt and subsequently crystallize a film having a substantial length, e.g., 900 mm or more.

In one setup, the line beam may be shaped by passing the laser output through a field definition unit, which in the simplest case may be a slit shaped aperture. Projection optics can then be used to image the slit onto the film. For this setup, it is desirable to have a relatively low beam divergence to reduce the amount of light incident on the beam stops which form the slit. In addition to being wasted, the light hitting the beam stops can create heating problems.

Excimer gas discharge laser sources are capable of producing the high power pulses suitable for generating a laser crystallization line beam, as described above. For example, relatively high power, excimer laser sources have been used successfully in photolithograpy applications. These excimer laser sources are typically line narrowed and emit a beam having a cross section with a short axis of about 3 mm and a long axis of about 12 mm. Generally, excimer laser sources for lithography employ metastable resonators established by a diffraction grating (in Littrov arrangement) and flat output coupler (i.e. a plano—plano resonator). With this arrangement, a beam with a relatively high divergence is produced.

With the above considerations in mind, applicant discloses devices and methods for creating a low divergence, high power laser beam for material processing applications.

### SUMMARY OF THE INVENTION

In a first aspect of an embodiment of the invention, a thin beam laser crystallization apparatus for selectively melting a film deposited on a substrate may comprise a laser source producing a pulsed laser output beam, the source having an oscillator comprising a convex reflector and a plano output coupler; and an optical arrangement focusing the beam in a first axis and spatially expanding the beam in a second axis to produce a line beam for interaction with the film.

For this aspect, the convex reflector may be cylindrical defining a cylinder axis, and may be positioned with the cylinder axis parallel to a first beam dimension, with the optical arrangement focusing the first beam dimension in the first axis. In one embodiment, the laser source may further comprise an amplifier, and in a particular embodiment the laser source may further comprise an optic, e.g., lens, converging an output beam from the oscillator for input into the amplifier. A polarizer may be interposed between the reflector and output coupler.

In one arrangement, the apparatus may include a beam mixer and/or a temporal pulse stretcher. The oscillator may be an excimer gas discharge oscillator. In one setup, the convex reflector may be spaced from the plano output coupler by a distance, L, the convex reflector may have a radius of curvature, r, and the ratio r/L may be in the range of 0.5 to 5. In a particular setup, the distance, L may be in the range of 1.0 m to 2.0 m and the radius of curvature, r may be in the range of 2.0 m to 3.0 m.

In another aspect of an embodiment, a thin beam laser crystallization apparatus for selectively melting a film deposited on a substrate may comprise an excimer gas discharge laser source producing a pulsed output beam, the source having an oscillator with a low divergence unstable resonator configuration producing an oscillator output beam having low divergence in a selected beam axis; and an optical arrangement focusing the beam in the selected beam axis and spatially expanding the beam in an axis orthogonal to the selected beam axis to produce a line beam for interaction with the film. In one embodiment, the oscillator may comprise a convex reflector and a plano output coupler, and in a particular embodiment, the convex reflector may be cylindrical defining a cylinder axis, the reflector may be positioned with the cylindrical axis parallel to a first beam dimension, the first beam direction corresponding to the selected beam axis.

For this aspect, the laser source may comprise an amplifier, and in one arrangement, the laser source may comprise a lens operating on an output beam from the oscillator prior to input into the amplifier.

For another aspect of an embodiment, a thin beam laser crystallization apparatus for selectively melting a film deposited on a substrate may comprise a means for producing a pulsed output beam having divergence in a selected beam axis lower than a divergence obtained using a comparable piano—plano oscillator; and a means for focusing the beam in the selected beam axis and spatially expanding the beam in an axis orthogonal to the selected beam axis to produce a line beam for interaction with the film. In one implementation, the producing means may comprise a cylindrical convex reflector and a substantially flat output coupler and in a particular implementation, the producing means may comprise an excimer gas discharge laser source having an oscillator and an amplifier. For this aspect, the laser source may further comprise an optic converging an output beam from the oscillator for input into the amplifier.

### BRIEF DESCRIPTION OF THE DRAWINGS

FIG. 1 shows a schematic view of the primary components of an exemplary production system for crystallizing an amorphous silicon film;

FIG. 2 shows a schematic view of a two chamber laser source;

FIG. 3 shows a schematic, sectional view as seen along line 3-3 in FIG. 2; and

FIG. 4 shows a schematic, sectional view as seen along line 4-4 in FIG. 2.

### DETAILED DESCRIPTION OF PREFERRED EMBODIMENTS

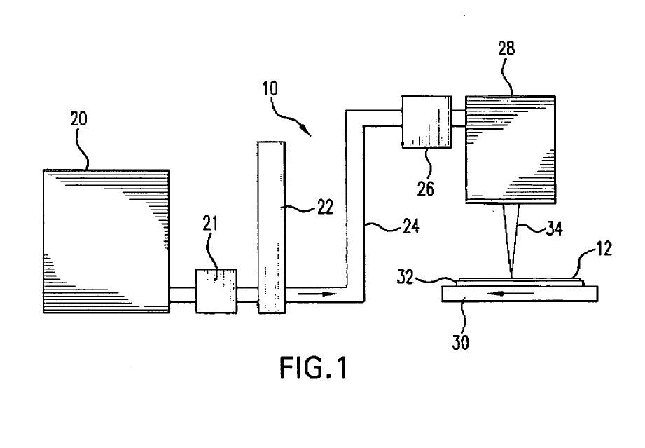

Referring initially to FIG. 1, there is shown a schematic, not to scale, view of the primary components of a production system, designated generally system 10, for processing a material with a laser beam, e.g., crystallizing an amorphous silicon film 12. Although the following description will described with reference to silicon film crystallization, it is to be appreciated that the principals will be equally applicable to other applications in which a laser beam is used to process a material.

As shown in FIG. 1, the system 10 may include a laser source 20 for generating a pulsed laser beam. The system 10 may further include a beam mixer 21 for increasing an intensity symmetry along one or more selected transverse axes of the beam, a pulse stretcher 22 for increasing pulse duration and/or a beam delivery unit 24 which may have a mechanism to actively steer the beam and/or an active beam expander.

More details regarding a beam mixer may be found in copending, co-owned U.S. patent application entitled, “DEVICE AND METHOD TO STABILIZE BEAM SHAPE AND SYMMETRY FOR HIGH ENERGY PULSED LASER APPLICATIONS” to Hofmann attorney docket number 2006-0039-01 filed concurrently herewith, the entire contents of which are hereby incorporated by reference.

More details regarding a pulse stretcher may be found in copending, co-owned U.S. patent application entitled, “HIGH POWER EXCIMER LASER WITH PULSE STRETCHER” to Hofmann et al., attorney docket number 2006-0040-01 filed concurrently herewith, the entire contents of which are hereby incorporated by reference.

Continuing with FIG. 1, the system 10 may further include a stabilization metrology module 26 for measuring one or more beam characteristics, e.g., wavefront and/or beam pointing and generating control signals for use by the active steering unit and/or the active beam expander. System 10 may also include an optics module 28 for beam homogenization, beam shaping and/or beam focusing, and a moveable stage system 30 for holding and positioning a silicon film 12 that has been deposited on a substrate 32, which can be, for example, glass. A layer of buffer material (not shown) may be interposed between the glass and the silicon layer.

In more detail, the optics module 28 which may include a homogenizing unit, a field definition unit having opposed beam stops which establish a slit-shaped aperture and a short-axis focusing/long-axis expanding optics unit which images the slit-shaped aperture at the film. All of units of the module may be arranged along a common beam path. When used, the homogenizing unit may include one or more optics, e.g., lens arrays, distributed delay devices, etc., for homogenizing the beam in the short-axis and one or more optics, e.g., lens arrays, distributed delay devices, etc., for homogenizing the beam in the long-axis.

More details regarding a beam delivery unit, stabilization metrology module and optics module may be found in copending, co-owned U.S. application Ser. No. 11/138,001, titled “SYSTEMS AND METHODS FOR IMPLEMENTING AN INTERACTION BETWEEN A LASER SHAPED AS A LINE BEAM AND A FILM DEPOSITED ON A SUBSTRATE” filed on May 26, 2005, the entire contents of which are incorporated by reference.

In overview, the system 10 shown in FIG. 1 and described in greater detail below can be configured to generate a focused thin beam 34, e.g. line beam, having a width at the film 12 of about 20 microns or less (short-axis), e.g. 3-4 microns, and a length of 700 mm or more (long-axis) and a depth of focus (DOF) of about +/−30 to 50 microns. Each pulse of the focused thin beam can be used to melt a strip of amorphous silicon, and after the end of the pulse, the molten strip crystallizes. In particular, the molten strip crystallizes in a lateral growth process in which grains grow in a direction parallel to the short-axis. Grains grow inward (parallel to the short-axis) from both edges and meet, creating a ridge (a so-called grain boundary protrusion) along the center of the strip which extends out of the plane of the silicon film. The stage is then moved, either incrementally or continuously, to expose a second strip that is parallel to and overlaps a portion of the first strip. During exposure, the second strip melts and subsequently crystallizes. An overlap sufficient to re-melt the ridge may be used. By re-melting the ridge, a relatively flat film surface (e.g., peak-to-peak value of ˜15 nm) may be maintained. This process, which is hereinafter referred to as thin beam directional crystallization (TDX) is typically repeated until the entire film is crystallized.

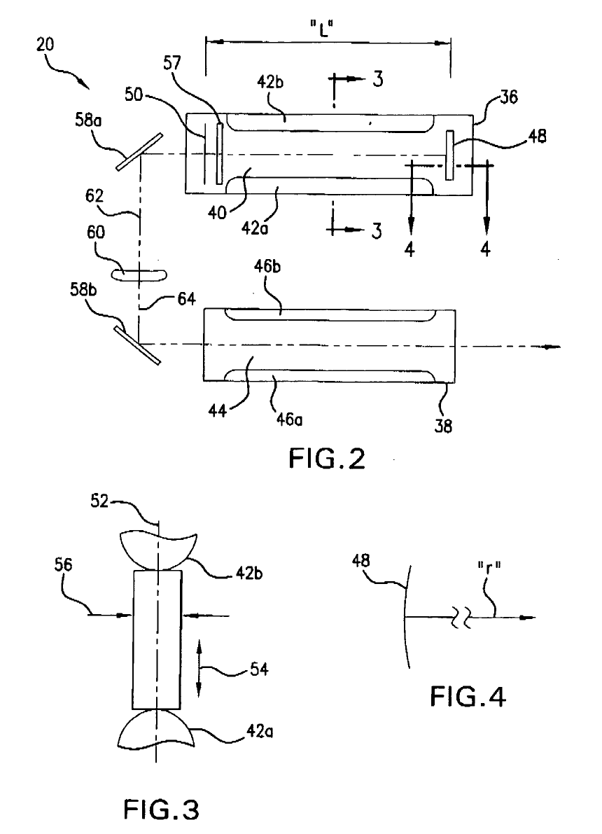

As shown in FIG. 2, the laser source 20 may be a two chamber system having an oscillator 36, e.g., power oscillator and an amplifier 38, e.g., power amplifier, and accordingly, may be referred to as a so-called POPA laser source. In one implementation of the crystallization process described above, a 6 Khz (6000 pulses per second) POPA laser may be used with pulse energies of approximately 150 mJ-225 mJ. Although a single pass amplifier 38 is shown, it is to be appreciated that, depending on the application, a multiple pass amplifier or in some cases a ring amplifier may be used. FIG. 2 illustrates that the oscillator 36 may form a discharge chamber 40 which may contain two elongated electrodes 42a,b, and a suitable laser gas, e.g., XeCl, XeF, etc. Similarly, the amplifier 38 may form a discharge chamber 44 which may contain two elongated electrodes 46a,b, and a suitable laser gas, e.g., XeCl, XeF, etc. The chambers 40, 44 may also include a high voltage source (not shown) to create an electric discharge between the electrodes, a preionizer system (not shown), a tangential fan (not shown) for circulating the laser gas between the electrodes, one or more water-cooled finned heat exchangers (not shown), metrology equipment (not shown) to measure various pulse parameters, e.g. pulse energy, and a control system (not shown).

FIG. 2 further shows that the oscillator 36 may include a convex reflector 48 and a plano output coupler 50. For example, the convex reflector may be cylindrical defining a cylinder axis 52 (see FIGS. 3 and 4) such as a UV grade fused silica reflector having a convex surface radius of curvature of 3.00+/−0.03 m (e.g. for use in a cavity having length, L of about 1.5 m) and having a excimer grade reflective coating on the surface with reflectivity greater that 99% at a zero degree angle of incidence. For the plano output coupler 50, a UV grade fused silica coupler with wedge less than 5 arc minute, coated on one side with a UV grade anti-reflective coating and on the other with a UV grade reflective coating with reflectivity of about 30%+/−4% at a zero degree angle of incidence may be used. Alternatively, the reflector 48 may be convex in more than one axis, e.g. having a spherical or aspheric surface.

With the arrangement shown in FIG. 2, the oscillator 36 may have a low divergence unstable resonator configuration producing an oscillator output beam having low divergence in one or more transverse beam axes. In particular, the oscillator 36 shown may have a divergence in one or more selected beam axes that is lower, in some cases appreciable lower, than the divergence obtained using a comparable plano—plano oscillator (not shown).

FIGS. 3 and 4 illustrate the beam axis for an oscillator having a cylindrical convex reflector 48. As shown, the cylinder may be aligned with its axis 52 parallel to the direction 54 corresponding to a path from one electrode 42a to 42b. This structure results in a beam with low divergence in the short axis 56. This short axis 56 of the beam can then be optically manipulated to create the short axis of the line beam 34 (FIG. 1).

FIG. 2 shows that the apex of the convex reflector 48 may be spaced from the plano output coupler by the distance, L. Also, as seen in FIG. 4, the convex reflector 48 may have a radius of curvature, r. For the oscillator 36 and the ratio r/L may be in the range of about 0.5 to 5. In a typical setup, the distance, L may be in the range of about 1.0 m to 2.0 m and the radius of curvature, r may be in the range of about 2.0 m to 3.0 m.

A polarizer 57 may be interposed between the reflector and output coupler e.g., establishing a beam having primarily s-polarization to, among other things, increase reflectivity at reflective optics such as turning mirrors 58a,b. For example, the polarizer may be a flat, CaF_{2, 40} mm OD, 7 mm thick, clocked, aligned at the proper angle and mounted.

FIG. 2 further shows that the laser source may include an optic 60, e.g. one or more lenses, mirrors, prisms, wedges, etc, converging an output beam 62 from the oscillator 36 to create a converging input beam 64 directed toward the amplifier. For example, the optic 60 may be used to improve laser efficiency. In one implementation, an f=4.3 m spherical lens was positioned between the oscillator 36 and amplifier 38. In some cases, a cylindrical lens, e.g. f=1.65 m may be used for the optic 60. The lens to system aperture distance may be about 2.0 m and the distance of lens to center of the amplifier 38 may be about 1.2 m. The purpose of the optic 60 is to funnel more of the oscillator 36 energy through the amplifier 38 and thereby increase total laser energy. The focal length was chosen such that the long-axis beam waist divergence * focal length remains similar to the open aperture (electrode gap) of the oscillator 36 and amplifier 38 chambers. This means, the lens is not actually focusing the beam, but rather contains it. The optic 60 can also serve to reduce the short axis wavefront curvature and makes the output more collimated. Use of the optic is particularly useful when the oscillator 36 and amplifier 38 have the same electrode spacing. For this case, the absence of an optic 60 may cause a diverging beam from the oscillator 36 to overfill the amplifier 38 and waste power. Use of a system where the oscillator 36 and amplifier 38 have the same electrode spacing may allow both chambers to use the same discharge voltage, simplifying timing and control of the laser source 20.

While the particular aspects of embodiment(s) described and illustrated in this patent application in the detail required to satisfy 35 U.S.C. §112 is fully capable of attaining any above-described purposes for, problems to be solved by or any other reasons for or objects of the aspects of an embodiment(s) above described, it is to be understood by those skilled in the art that it is the presently described aspects of the described embodiment(s) of the present invention are merely exemplary, illustrative and representative of the subject matter which is broadly contemplated by the present invention. The scope of the presently described and claimed aspects of embodiments fully encompasses other embodiments which may now be or may become obvious to those skilled in the art based on the teachings of the Specification. The scope of the present invention is solely and completely limited by only the appended Claims and nothing beyond the recitations of the appended Claims. Reference to an element in such Claims in the singular is not intended to mean nor shall it mean in interpreting such Claim element “one and only one” unless explicitly so stated, but rather “one or more”. All structural and functional equivalents to any of the elements of the above-described aspects of an embodiment(s) that are known or later come to be known to those of ordinary skill in the art are expressly incorporated herein by reference and are intended to be encompassed by the present Claims. Any term used in the Specification and/or in the Claims and expressly given a meaning in the Specification and/or Claims in the present Application shall have that meaning, regardless of any dictionary or other commonly used meaning for such a term. It is not intended or necessary for a device or method discussed in the Specification as any aspect of an embodiment to address each and every problem sought to be solved by the aspects of embodiments disclosed in this Application, for it to be encompassed by the present Claims. No element, component, or method step in the present disclosure is intended to be dedicated to the public regardless of whether the element, component, or method step is explicitly recited in the Claims. No claim element in the appended Claims is to be construed under the provisions of 35 U.S.C. §112, sixth paragraph, unless the element is expressly recited using the phrase “means for” or, in the case of a method claim, the element is recited as a “step” instead of an “act”.

It will be understood by those skilled in the art that the aspects of embodiments of the present invention disclosed above are intended to be preferred embodiments only and not to limit the disclosure of the present invention(s) in any way and particularly not to a specific preferred embodiment alone. Many changes and modification can be made to the disclosed aspects of embodiments of the disclosed invention(s) that will be understood and appreciated by those skilled in the art. The appended Claims are intended in scope and meaning to cover not only the disclosed aspects of embodiments of the present invention(s) but also such equivalents and other modifications and changes that would be apparent to those skilled in the art.

What is claimed is:

1. A thin beam laser crystallization apparatus for selectively melting a film deposited on a substrate, the apparatus comprising:
a laser source producing a pulsed laser output beam, the source having an oscillator comprising a convex reflector and a plano output coupler; and
an optical arrangement focusing the beam in a first axis and spatially expanding the beam in a second axis to produce a line beam for interaction with the film.

2. An apparatus as recited in claim 1 wherein the convex reflector is cylindrical defining a cylinder axis, the reflector is positioned with the axis parallel to a first beam dimension, the first beam dimension corresponding to the first axis.

3. An apparatus as recited in claim 1 wherein the laser source further comprises an amplifier.

4. An apparatus as recited in claim 3 wherein the laser source further comprises an optic converging an output beam from the oscillator for input into the amplifier.

5. An apparatus as recited in claim 4 wherein the optic is a lens.

6. An apparatus as recited in claim 1 further comprising a beam mixer.

7. An apparatus as recited in claim 1 further comprising a temporal pulse stretcher.

8. An apparatus as recited in claim 1 wherein the oscillator is an excimer gas discharge oscillator.

9. An apparatus as recited in claim 1 wherein the convex reflector is spaced from the piano output coupler by a distance, L, the convex reflector has a radius of curvature, r, and the ratio r/L is in the range of 0.5 to 5.

10. An apparatus as recited in claim 1 wherein the distance, L is in the range of 11.0 m to 2.0 m and the radius of curvature, r is in the range of 2.0 m to 3.0 m.

11. An apparatus as recited in claim 1 further comprising a polarizer interposed between the reflector and output coupler.

12. A thin beam laser crystallization apparatus for selectively melting a film deposited on a substrate, the apparatus comprising:
an excimer gas discharge laser source producing a pulsed output beam, the source having an oscillator with a low divergence unstable resonator configuration producing an oscillator output beam having low divergence in a selected beam axis; and
an optical arrangement focusing the beam in the selected beam axis and spatially expanding the beam in an axis orthogonal to the selected beam axis to produce a line beam for interaction with the film.

13. An apparatus as recited in claim 12 wherein the oscillator comprises a convex reflector and a piano output coupler.

14. An apparatus as recited in claim 13 wherein the convex reflector is cylindrical defining a cylinder axis, the reflector is positioned with the cylindrical axis parallel to a first beam dimension, the first beam dimension corresponding to the selected beam axis.

15. An apparatus as recited in claim 12 wherein the laser source further comprises an amplifier.

16. An apparatus as recited in claim 15 wherein the laser source further comprises a lens operating on an output beam from the oscillator prior to input into the amplifier.

17. A thin beam laser crystallization apparatus for selectively melting a film deposited on a substrate, the apparatus comprising:
a means for producing a pulsed output beam having divergence in a selected beam axis lower than a divergence obtained using a comparable plano—plano oscillator; and
a means for focusing the beam in the selected beam axis and spatially expanding the beam in an axis orthogonal to the selected beam axis to produce a line beam for interaction with the film.

18. An apparatus as recited in claim 17 wherein the producing means comprises a cylindrical convex reflector and a substantially flat output coupler.

19. An apparatus as recited in claim 17 wherein the producing means comprises an excimer gas discharge laser source having an oscillator and an amplifier.

20. An apparatus as recited in claim 19 wherein the laser source further comprises an optic converging an output beam from the oscillator for input into the amplifier.
